(19) United States
(12) Patent Application Publication
(10) Pub. No.: US 2019/0087775 A1
(43) Pub. Date: Mar. 21, 2019

(54) SYSTEMS AND METHODS FOR SECURE DELIVERY AND TRACKING OF PACKAGES

(71) Applicant: Benjamin Buehre, Livermore, CA (US)

(72) Inventor: Benjamin Buehre, Livermore, CA (US)

(21) Appl. No.: 15/706,099

(22) Filed: Sep. 15, 2017

(51) Int. Cl. G06Q 10/08

(52) U.S. Cl. CPC G06Q 10/0833; H04W 4/008; G06Q 10/0832

(57) ABSTRACT

A system to securely receive an item for delivery or pick-up in a predetermined location includes a housing with a storage chamber, a door, and a lock to secure the door to the housing; a cover for the housing with a decor to hide the housing and provide a decor matching a theme of the predetermined location; a controller to open the door upon authentication of a delivery or pick up person; a sensor to detect presence or absence of the item; and a wireless transceiver coupled to the controller to communicate with a recipient that the item has been received or picked up.

### BACKGROUND

The present invention is related to secure delivery and tracking of packages.

The shipment of parcels for delivery to a home or office has been a cumbersome and time-consuming process for both the commercial carrier delivering the parcel and for the parcel recipient. Typically, products purchased remotely, such as through a catalog or over the internet, must be delivered to a purchaser by a commercial carrier. Commercial carriers generally request that the intended recipient be present at the time of delivery. In the absence of the recipient, it is necessary for the commercial carrier to return the package to the delivery hub and await personal pickup by the recipient. This time-consuming process is frequently averted by agreement between the recipient and the commercial carrier that personal receipt of a delivered parcel is not required. In these cases, the commercial carrier commonly drops the package in an unsecured area near the front entrance of a building, such as near the front porch area of a home or office. However, this practice carries the obvious liability of exposing the commercial carrier and/or the recipient to the risk that the unsecured parcel may be stolen or possibly damaged by exposure to environmental elements.

In a parallel thread, in providing services, such as acceptance of an item for delivery, a delivery service provider may arrive at a residence or place of business to deliver or pick-up the item. However, without coordination between the user and the delivery service provider, multiple unsuccessful attempts to pick up the item may be made if the user is unavailable. This wastes time and money.

To address this issue, systems are known which provide user services at remote locations. For example, locker systems may receive items placed by a user in a locker, or cell, of the system, and securely store the item until a delivery service provider arrives at the locker system to pick up the item. However, locker systems may come in different shapes and sizes, and may have lockers located at various distances off the ground.

### SUMMARY OF THE SYSTEM

In one aspect, a system to securely receive an item for delivery or pick-up in a predetermined location includes a housing with a storage chamber, a door, and a lock to secure the door to the housing; a cover for the housing with a decor to hide the housing and provide a decor matching a theme of the predetermined location; a controller to open the door upon authentication of a delivery or pick up person; a sensor to detect presence or absence of the item; and a wireless transceiver coupled to the controller to communicate with a recipient that the item has been received or picked up.

In another aspect, a system provides an inconspicuous smart storage device that allows temporary storage of goods for pickup or delivery at home or home office from a commercial carrier. The temporary storage device facilitates temporary storage of the delivered goods by providing a compartment with an access door associated with a locking device. Upon delivery, the commercial carrier is able to secure the delivered goods within the compartment by deactivating the locking device associated with the access door. The delivered goods remain securely stored within the temporary storage device until the locking device is unlocked by the intended recipient of the goods. Since the storage or locking device does not look like a container, thieves would miss it. Yet, the temporary storage can provide smart handling of items by reporting and tracking delivery/pickup so that the device can act as a micro UPS store or postal office.

The system is also configured with a smart phone controlled switch connected to the locking device for providing unlocking and locking of the locking device. An input device is further associated with the temporary storage device for inputting a temporary access code or personal security code to access the compartment of the device. A control unit is also associated with the temporary storage device where the control unit is communicatively linked to the input device and electrical switch. In this aspect of the system, a security code is stored in a memory associated with control unit and an access code is entered into the input device and transmitted to the control unit. Access to the compartment of the temporary storage device is granted upon entry of a valid access code and verification by the control unit. The temporary access code may be deactivated after first use. The electrical switch is then energized by communication with the control unit to cause unlocking of the locking device so that the access door may be opened by the commercial carrier. The good is then placed within the compartment, the access door closed, whereupon the locking device is returned to the locked position so that the good is securely stored inside. Retrieval of the good by the intended recipient may then be provided by entry of a similar temporary access code or permanent security code in the manner described above.

The system supports ordering goods for delivery into the temporary storage device, including ordering goods from a merchant, establishing delivery by commercial carrier, providing an access code to the commercial carrier, and storing an access code into a memory associated with the control unit, wherein the commercial carrier enters the provided access code into the input device and the access code is transmitted to the control unit. Access to the compartment of the temporary storage device is granted upon entry of a valid access code and verification by the control unit. The electrical switch is then energized by communication with the control unit to cause unlocking of the locking device so that the access door may be opened by the commercial carrier. The good is then placed within the compartment, the access door closed, whereupon the locking device is returned to the locked position with the good securely stored inside. The temporary access code is then deactivated by the control unit.

Implementations of the above system may include one or more of the following. The delivery system may include a cabinet, a plurality of storage cells having controlled access and being disposed in a plurality of zones within the cabinet, a user evaluation device configured to detect physical characteristics of a user, and a control processor. The control processor may be configured to provide, in response to a user request, physical access to cells located in a selected at least one of the zones, where the selection is based on detected physical user characteristics. The housing can be temperature regulated for grocery deliveries. This can be done with refrigeration components and/or heat lamp to keep the delivered content at a desired temperature.

In accordance with the disclosed embodiments, an interactive user interface for a system providing user services, the services having functional characteristics and the user interface, may include a user evaluation device for detecting facial and other characteristics of a user and a processor. The processor may be configured to respond to a user request for services, select at least one of the functional characteristics based on the detected physical characteristics, and generate commands to cause an associated apparatus to provide at least one of the services and record such provisioning of services based in part on the user facial or functional characteristic.

In accordance with the disclosed embodiments, a system providing services to a user may include a detector configured to detect facial or physical characteristics of the user, a display device configured to present information prompting the user to provide inputs specifying the services, the information having a plurality of formats, an input device configured to receive the user inputs, and a processor. The processor may be configured to generate commands to the display device to display the information in a selected one of the formats, the format selection being based on the detected physical characteristics and to generate commands to associated apparatus to provide the specified service, the commands being based on the received user input.

In accordance with the disclosed embodiments, a method for receiving, from a user, a delivery item for delivery by a delivery service provider may include receiving a request from the user to deposit a delivery item in an inconspicuous cabinet or enclosure that blends in with the environment to hide valuables in the cabinet, the cabinet comprising a plurality of controlled-access storage cells disposed in a plurality of zones within the cabinet; detecting physical characteristics of the user with a user evaluation device; providing, in response to the request, physical access to a selected cell located in a selected at least one of the zones, the selection being based on detected physical user characteristics, receiving the delivery item in the selected cell from the user; and providing access to the selected cell to only a delivery service provider.

### BRIEF DESCRIPTION OF EXEMPLARY DRAWINGS

The features and advantages of the present system reside in the details of construction and operation as more fully depicted, described, and claimed below, with particular reference to the accompanying drawings, wherein like numerals refer to like parts throughout, and wherein:

FIG. 1 shows an exemplary building with an inconspicuous storage device for storing items to be picked-up or delivered by one or more carriers.

FIG. 2A-2D show examples of various inconspicuous storage devices including furniture, statute, or plant container, among others.

FIG. 3 shows a system to deliver and/or pick-up items secured by the storage device of FIG. 2.

FIG. 4 shows exemplary electronics in the storage device of FIG. 2.

FIGS. 5-6 show exemplary processes operating in conjunction with the storage devices of FIGS. 2A-2D.

FIG. 7 shows an exemplary temperature controlled storage device.

It is to be understood that both the foregoing general description and the following detailed description are exemplary and explanatory only and are not restrictive of the system, as claimed.

The accompanying drawings, which are incorporated in and constitute a part of this specification, illustrate several embodiments of the system and together with the description, serve to explain the principles of the system.

### DESCRIPTION OF THE EMBODIMENTS

Reference will now be made in detail to the present, exemplary embodiments disclosed herein, including examples of which are illustrated in the accompanying drawings. Wherever possible, the same reference numbers will be used throughout the drawings to refer to the same or like parts.

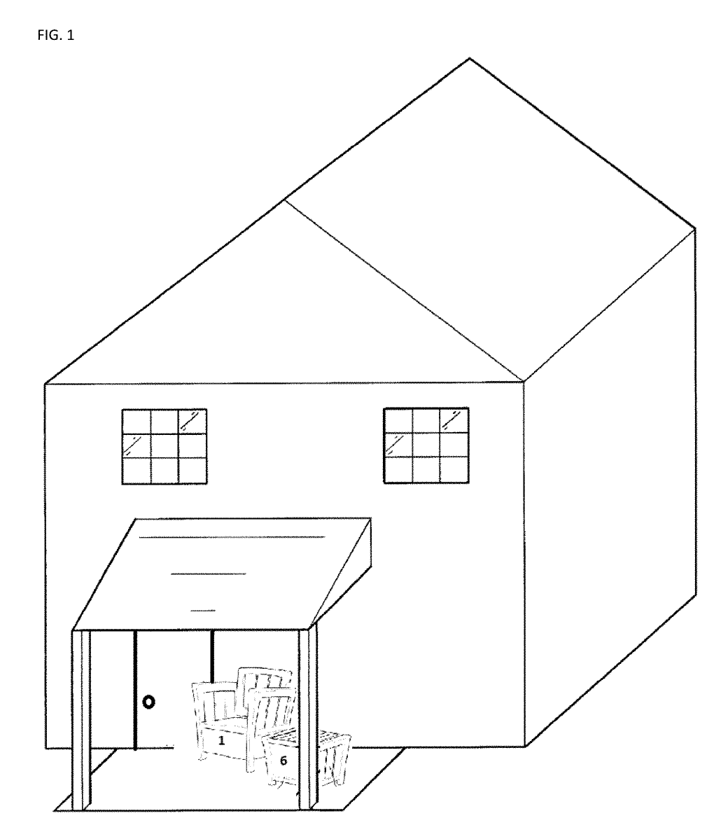

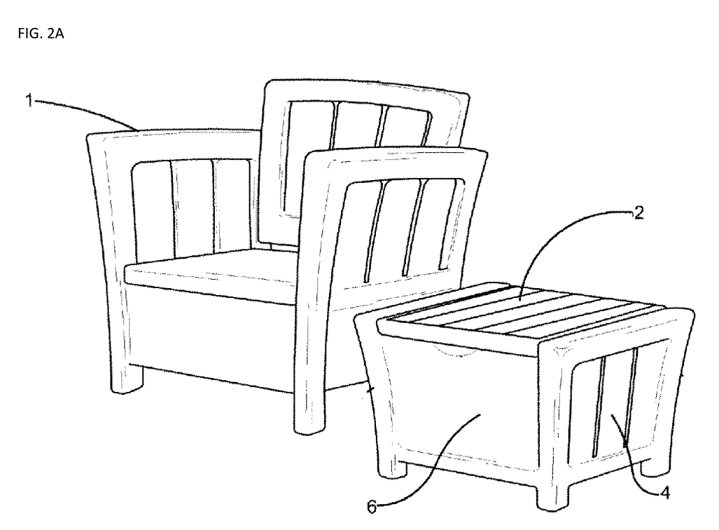

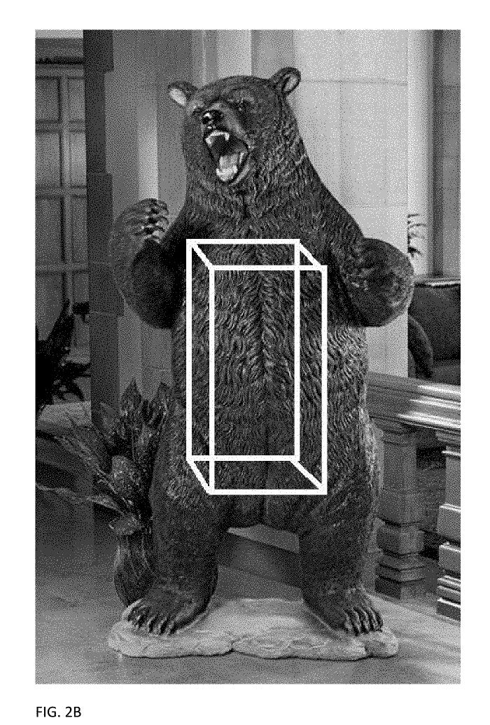

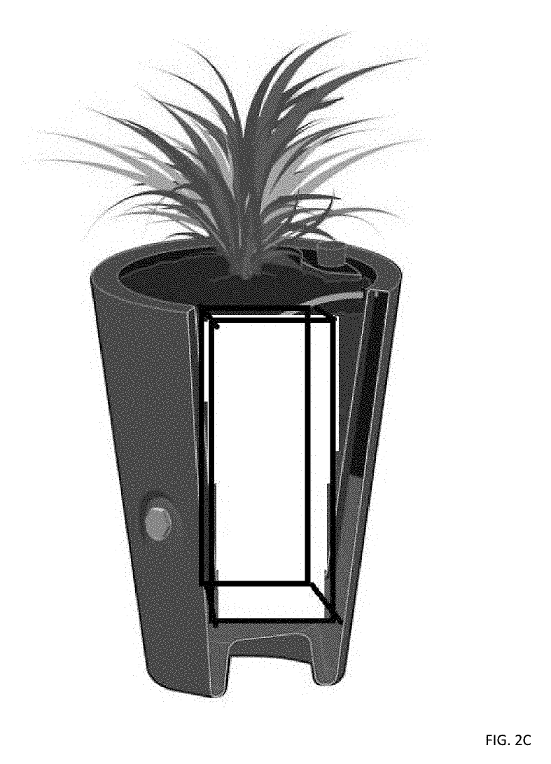

FIG. 1 shows an exemplary building with an inconspicuous storage device for storing items to be picked-up or delivered by one or more carriers, wherein the inconspicuous storage device is in plainsight but not obvious to a thief that it may contain valuables therein. In the embodiment of FIG. 1, the inconspicuous storage device is positioned on the front porch, and is detailed in FIG. 2A. Other variations can be used, and FIGS. 2A-2C show examples of various inconspicuous storage devices in addition to furniture, including statutes (FIG. 2B) or plant container (FIG. 2C), or rock enclosure (FIG. 2D), among others.

Referring to FIG. 2A, the present system includes two temporary storage devices 1 and 4 for temporarily storing goods for delivery or pickup. Focusing on the exemplary table storage embodiment, the storage device 4 includes a compartment (not shown) having an access door 6 with a locking device associated therewith. The door can be suitably locked by a key, electronic coding device or any other locking mechanism. The storage device 1 or 4 may be any shape or size, constructed of any suitable material, such as, metal, plastic, wood and/or the like and include any number of compartments, openings and/or the like. The system can have energy scavenging device 2 such as solar cells that capture and convert solar energy into electricity to charge an energy storage device such as a battery to power the devices 1 and 4. Other energy converters can be used in addition to solar cells, including thermoelectric generators, for example.

In FIG. 2B, a statute such as a bear statute can be used where each statute is so natural-looking that it can be used to hide valuables in an electronically controlled vault. Whether used individually or with several grouped together, the statute can be used to store valuables in plain sight of potential thieves, but will also add to the natural surroundings. Again, solar cells can be used to capture ambient energy to power the device.

In FIG. 2C, a large plant pot can be used where each pot contains a hidden storage vault or chamber that is unobvious to unaided eye. Whether used individually or with several grouped together, this rock enclosure can be used to store valuables in plain sight of potential thieves, but will also add to the natural surroundings.

In FIG. 2D, an Artificial Rock Enclosure can be used where each rock formation is so natural-looking that it's nearly impossible to distinguish it from the real thing. Whether used individually or with several grouped together, this rock enclosure can be used to store valuables in plain sight of potential thieves, but will also add to the natural surroundings.

In the illustrated embodiment, the statute, pot, or cover preferably includes a design on the cover to provide an aesthetically pleasing appearance. For example, the cover can include a design having a professional or college logo or mascot thereon. Furthermore, the cover can include a design such that the cover will blend in with the background. For example, the cover can include a nature scene thereon (e.g., trees and flowers), a fence, etc. It is contemplated that the design could be any picture or image. Furthermore, the cover can be made of any fabric or material with the design integrally formed as part of the fabric or material or placed on the fabric or material. Preferably, the cover reflects heat and/or sunlight and prevents pressure inside the cabinet from getting too high.

The storage device may be free-standing or incorporated into any existing structure, device or element, such as, for example, the device may be integral with a bench, planter, statute, wall and/or the like. Any portion of the lock box may be decorated, painted or designed to match the building facade or to imitate a structure or plant (e.g., to conform to area specific housing community guidelines). The temporary storage device could also be associated with a refrigerator, a heater, or insulating box to maintain the compartment at a desired temperature in cases where the contents of the parcel contained temperature sensitive goods or perishable items, such as frozen foods or produce. The box may include different size shelves for different sized packages, a cooler for goods that require temperature control (e.g. groceries, frozen food deliveries and the like), a bar to hang certain goods (e.g., dry-cleaning, new clothes, rugs, posters and the like) or any other desired storage compartment. In an alternative embodiment, the temporary storage device may configured in a weather-proof or water-resistant manner to temporarily protect the parcel from environmental elements or degradation. Moreover, the storage compartments may be easily removable or interchangeable to allow the user to select a preferred storage feature. The lock box may optionally include a portion which allows visual inspection of the contents (e.g., window).

The storage device may be self-powered. For example, the table storage device 4 may have solar panels 2 to provide perpetual power to lock/unlock and to provide data reporting and related Internet-of-Things (IOT) functionality. The solar panels may be used to power an electronic light such as LEDs to provide a delivery or a pickup indication. The storage device may also include any other indication device to provide convenient notification of the existence of a delivery waiting inside the lock box (e.g., flag, light and or the like). The storage device may be suitably configured with the appropriate electronics and telecommunications technology to allow the transmission of a signal to the inside of a home or office, to a pager, to a personal digital assistant, to a computer and/or the like. The signal may indicate that the access door has been opened, closed or tampered with. The internal portions of the storage device may include a suitable detector (pressure, light beam, weight and/or the like) which may also transmit a signal indicating the existence of a delivery.

Such an indication device may comprise an LED which is turned on by the processor. Deposit of a parcel inside the compartment of the storage device would cause actuation of the microswitch which would cause current to be applied to the lamp and further cause illumination thereof indicating that a parcel has been placed in the storage device. When the parcel is removed from the storage device, the weight removed from the microswitch would cause the switch to open and current to be removed from the lamp, causing termination of the illumination thereof.

Sensors for detecting proper closing of the access door may also be used and suitable communication technology for transmitting a signal identifying the status of the storage device may be practiced.

In an alternative embodiment of the present system a locking device may be configured as a one-way access door such that a delivered good may be placed in the temporary storage device, but not removed without accessing the lock, wherein the lock may be located on any access door of the system. Such an embodiment comprises a self-locking door allowing one-time access into the temporary storage device 4, where the access door 6 automatically locks or otherwise prevents access into the temporary storage device after delivery without activation from the intended recipient. In this embodiment, the compartment may include an internal baffle adjacent to the access door 6 which, when delivered goods are placed into the compartment through the access door 6, prevents access to the delivered good. Alternatively, the access door may be pivotally mounted and include a panel or flap which blocks access to the compartment when the first access door 6 is opened.

Disclosed embodiments include computer systems having a processor and computer-readable storage media that include code for instructions to perform disclosed processes. Disclosed embodiments can include various types of computer-readable memory or storage device, such as a random-access memory, a read-only memory, a mass storage device such as a hard disk, a CD, a DVD, and the like. Disclosed embodiments can include monitors, track balls, mice, keyboards, and the like. Disclosed embodiments can be connected to computers, cell phones, and other systems using a network. Various computers and systems can exchange information among the network. Disclosed embodiments can be deployed on any operation system or platform such as Linux based operating systems.

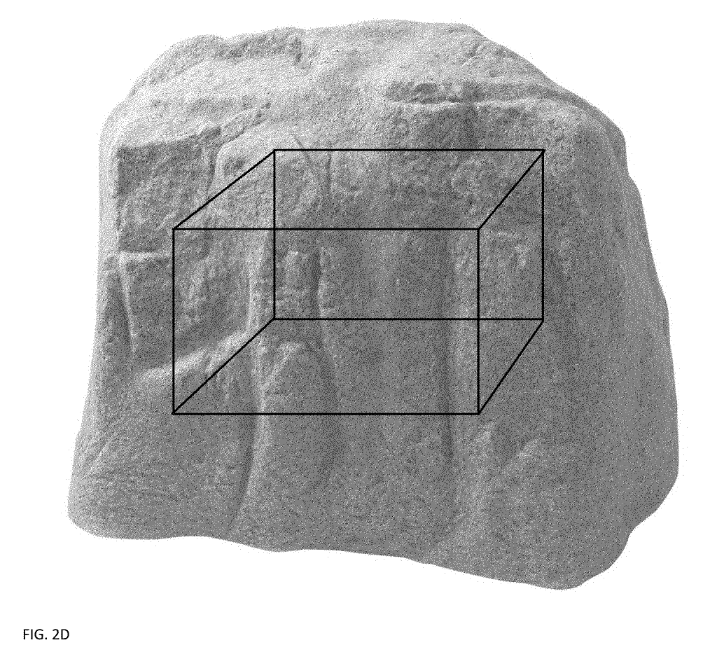

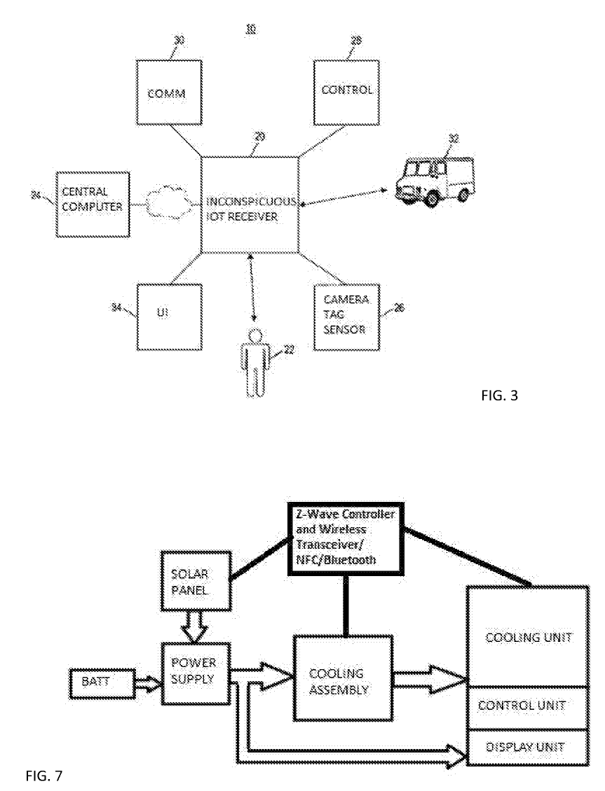

FIG. 3 shows an exemplary user service system 10 to receive shipped items, or to store items for pickup by courier services, among others. System 10 includes a locker storage device 20 serving a user 22. Coupled to storage device 20 is a user interface 34 and a user sensor 26. A controller 28 is also coupled to storage device 20, along with an optional communication module 30. A delivery service provider 32 delivers and receives delivery items to and from storage device 20.

Storage device 20 may be accessed by users and delivery service providers to deliver and retrieve items to and from secure lockers, or “cells,” in storage device 20. Items can include parcels, letters, periodicals, and the like. The delivery service provider can leave a specific item for a specific user in a specific cell. The cell can be manually or electronically locked. The cell can be accessed by those having approved access, such as users, or delivery service providers.

Delivery service providers may either drop off or retrieve items using a login or PIN through a local area network such as Wifi, Bluetooth, NFC, Zigbee, or Zwave to access a specific user account used to ship, bill, buy, or retrieve items. A user also may either drop off or retrieve items. A user may gain access to cells of storage device 20 in a number of ways, such as by scanning or swiping a form of identification, or by scanning or entering a code, login, or PIN. In particular, Z-Wave from Sigma Designs, Inc. is the leading wireless home control technology in the market today, with over 2100 certified interoperable products worldwide. Represented by the Z-Wave Alliance, and supported by more than 600 companies around the world, the standard is a key enabler of smart living solutions for home safety and security, energy, hospitality, office and light commercial applications. To satisfy the requirement for different network bandwidths and applications, various wireless communication technologies with different specifications are provided and applied in our daily products such as 3G and 4G products applied in a mobile communication system. Users may logon a network instantly through the connection of a mobile phone and a base station, and thus improving the convenience of use of the mobile phone significantly. In near-field wireless network system such as WiFi, Bluetooth, Zigbee, Zwave, RFID, and EnOcean systems applied for different purposes. The WiFi system can create a specific area network and encrypts such area network, so that only authorized uses may use the area network. The Bluetooth system is used extensively in many areas such as the data transmission of a wireless earphone, a wireless keyboard and mouse or between mobile phones. Since Bluetooth 4.0 comes with a better power saving mechanism, the Bluetooth system will be well developed in the future. The Zigbee, Zwave, and EnOcean systems feature low power consumption and low transmission rate, so that they are usually used for wireless sensing or detection and control such as household power supply control and medical treatment. The RFID system provides a relatively shorter transmission distance, so that the RFID system is generally applied in the areas of electronic fee collection system, identity recognition, logistics management, etc.

NFC is a short range wireless connectivity technology that enables the exchange of various types of information, such as numbers pictures, MP3 files or digital authorizations between two NFC enabled devices such as mobile phones or between a mobile phone and a compatible chip card or reader that are positioned close to each other. Applications for NFC include use as an access control for content and for services such as cashless payment, ticketing, etc. NFC is often defined as operating in a frequency range centered on 13.56 MHz. Communications between NFC-capable devices may exist in a variety of modes, including: peer-to-peer; active-passive (or reader-writer); and so-called card emulation.

The controller can act in more than one mode. For example, the controller can act (i) in the card emulation mode, thereby facilitating a credit-card reader to unlock the door of the device 1 or 4; and (ii) in the reader mode, thereby facilitating reading of smart posters or other various tags or other similar devices. In addition, it may be desired for the mobile phone to be capable of peer to peer information exchange with another mobile phone.

Using Bluetooth or NFC, cell phones and other wireless devices may also access system 10. A user may either login to a website relating to system 10, call into system 10, or wirelessly access system 10 using a cell phone or other wireless device. This may save the user time when the user wants to check to determine if a specific item has been delivered to storage device 20, to determine if there is an item waiting for the user, to determine if system 10 is available, or to determine the location of storage device 20. The user can also receive and send emails to and from system 10, that update the user as to a status of an item. An email can include an ID number, code, or other identifier, and the user can use his phone to authenticate, key the code into system 10 for verification, or scan the code. This may enable the user to physically access an item inside storage device 20. In a similar manner, as with the wireless device, a computer can also access system 10.

Storage device 20 can also interact with other locker systems. These other locker systems may communicate with storage device 20 by sharing information such as location, ability to accommodate a particular item size, and other information.

A central computer system 24 may also connect and interact with the locker system. Central computer system 24 may be operated by a company, such as a delivery service provider, a vending company, or any other business or entity. Central computer system 24 can operate system 10 if needed, such as by controlling cameras, microphones, cells, monitors, and other components included in or related to system 10. Central computer system 24 can send and receive instructions to and from the system 10, and vice versa. Central computer system 24 can also interact and communicate with entities that communicate with storage device 20, such as a users and delivery service providers.

Storage device 20 may include a user interface that includes a display such as a monitor, touch display, flat panel display, and the like. A user can input information into the locker system by entering information on the display, either by touch or other input device, such as a mouse or trackball. Display can also display information to the user.

Storage device 20 may include a user evaluation device, which may include sensors such as cameras or infrared detectors, to detect characteristics of a user. These characteristics may include physical characteristics, such as height, weight, reach, race, gait, or age of the user, or any other characteristic. These characteristics can be automatically captured by a detector or camera included in user evaluation device, and operated by controller 28. The detected characteristics can be used in determining a marketing or advertisement message that may be displayed on or in storage device 20, such as on the display.

Storage device 20 may include a card reader and video camera. Card reader can scan cards such as a driver's license, a credit card, etc., to identify and validate a person's identity, to pay for a service, and the like. Video camera may be used to view a user's identification, such as a driver's license, to identify and validate a person's identity, to pay for a service, and the like. Video camera 110 may also be used in the same manner as user evaluation device 180, such that video camera 110 may be used to detect characteristics of a user. Storage device 20 may include a printer and printer panel 125. Printer and printer panel 125 may be used to print labels, receipts, and other documents and information, which may or may not relate to cabinet items.

Storage device 20 may further include a keypad to receive user input, and a scanner. Scanner may be used to scan items, bar codes, cell phone screens, biometric characteristics of a user, and the like to determine information related to a user or a specific item. Thus, a user may use scanner to identify the user or to identify an item to be deposited or retrieved from storage device 20. Storage device 20 may also include a microphone and speakers. These items, together with controller 28 and user evaluation device, may be used to contact a user care or help center, thereby enabling a video chat between the user and the center. The help center may be operated by the same entity that operates central computer system 24, or may be a different entity.

Accordingly, when a user desires to deposit an item in a cell, the user's physical characteristics are detected by the user evaluation device. System 10 uses the detected characteristics to authenticate or secure a user with the security camera, and based on user physical attributes, can suggest or select a locker for a user. For example, when a user approaches storage device 20, and begins to use services of storage device 20, the user's detected characteristics will be used to select which zone of cells will be best suited for those detected characteristics. If the user desires to deposit an item, then those cells only within the selected zone will be available to the user. Alternatively, the zones may be pre-configured such that specific cells are included in specific zones without using user characteristics.

Additionally, the zones may be dynamically determined based on detected characteristics. For example, before a user approaches storage device 20, the zones are not specified in system 10. After system 10 has detected the characteristics of the user, the zones can be created based on these characteristics, thereby accommodating the specific user. Therefore, a taller user's characteristics may create a zone having a greater height than a shorter user's characteristics, and vice versa.

In some embodiments, a user may wish to retrieve an item from storage device 20. A user's information and characteristics may be stored in storage device 20 or central computer system 24 as an account. The user's characteristics may have been previously detected by the sensor 26 and user evaluation device, or previously entered by the user, for example, through a wireless device, computer, or through user interface 34. When a delivery service provider tries to deposit an item at system 10 for the user, the delivery service provider may scan a code, for example, on the item using the scanner 165. The user's stored information and characteristics can then be accessed, and used to determine into which zones of cells the delivery service provider may deposit the item.

If for some reason, the detected user characteristics are incorrect or inappropriate for a desired action, the user may modify them. The user can enter information on user interface 34 to modify or change the detected user characteristics. Further, the user may bypass the detection of characteristics, and enter characteristics manually into storage device 20 through user interface 34.

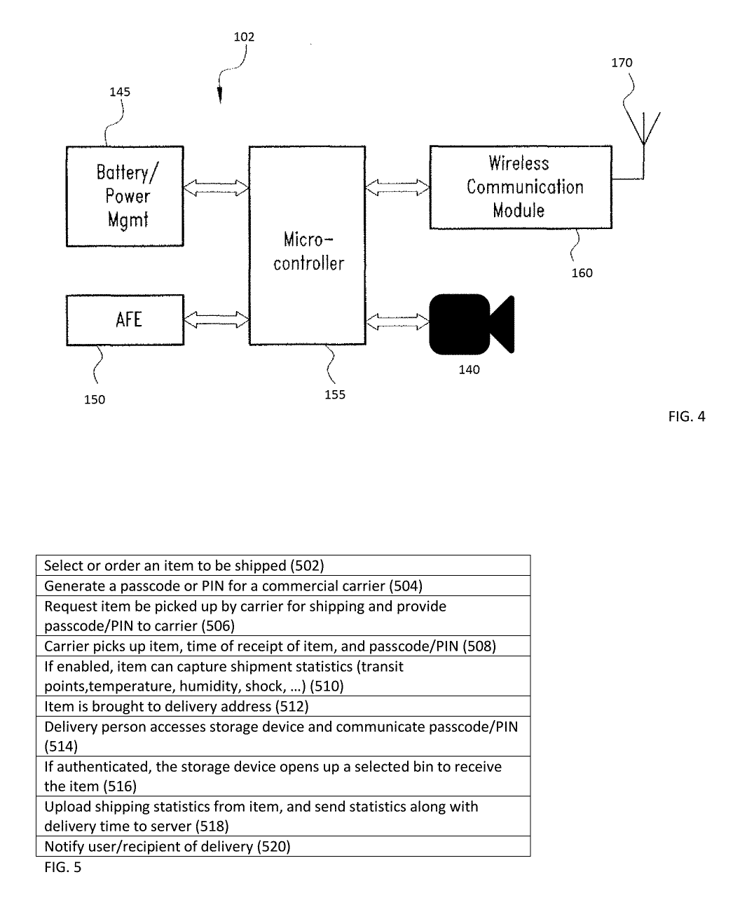

As shown in FIG. 4, a microcontroller 155 receives and processes signals from sensors 112-114, and converts those signals into an appropriate digital electronic format. The microcontroller 155 wirelessly transmits door open/close information in the appropriate digital electronic format, which may be encoded or encrypted for secure communications, corresponding to the sensed item pickup/deliver indication through a wireless communication module or transceiver 160 and antenna 170. Optionally, a camera 140 can be provided to visually capture people who open/close the door 6. While monitoring of the smart storage device 4 door access is continuous, transmission of item access information can be continuous, periodic or event-driven, such as when the storage space is full.

The sensors can detect force, load, tension and compression forces placed by items place in the storage device. Other data includes Acceleration; Velocity; Global absolute displacement; Local relative displacement; Rotation; Strain; Stress; Force; and Static-position video. Wind speed/direction; External temperature; weather parameters (rainfall, humidity, solar radiation, etc.); Internal or structural temperature; Mass loading (occupant count, etc.); Static tilt; Fatigue damage; Corrosion; Acoustic emission; and Moving-position video. A force is simply a push or pull to an object and can be detected by a load cell, pressure cell or strain sensor. A Load: Is simply a force applied to a structure. Ex: weight of vehicles or pedestrians, weight of wind pushing on sides. Tension & Compression are internal forces that make a member longer or shorter. Tension stretches a member and Compression pushes the member closer together. Acceleration can also be detected by Force-Balance (Servo) Piezoelectric Piezoresistive MEMS. Velocity can be measured by force-balance (servo) MEMS, or Mechanical Doppler Heated wire. A local Displacement sensor can be LVDT/Cable potentiometer Acoustic Optical/laser Temperature Electrical Optical fiber. A rotation sensor can be Gyro MEMS Gyro Tilt Electro-mechanical MEMS. A strain sensor can be a resistance gauge Vibrating wire Optical fiber Corrosion Electrical Chemical sensors. A traffic and/or crime sensor can be a microphone listening to acoustic emission, or Piezoelectric MEMS, for example, and sonar sound processing can be used to detect where crime activity is coming from.

The sensor 112-114, transceiver 160/antenna 170, and microcontroller 155 are powered by and suitable power source, which may optionally include an electromagnetic field (EMF) scavenging device 145, such as those known in the art, that convert ambient EMF (such as that emitted by radio station broadcasts) into small amounts of electrical power. The EMF scavenging device 145 includes a battery to buffer and store energy for the microcontroller 155, sensor 112-114, camera 140 and wireless communications 160/170, among others.

The circuit of FIG. 4 contains an analog front-end (“AFE”) transducer 150 for interfacing signals from the sensor 112-114 to the microcontroller 155. The AFE 150 electrically conditions the signals coming from the sensor 112-114 prior to their conversion by the microcontroller 155 so that the signals are electrically compatible with the specified input ranges of the microcontroller 155. The microcontroller 155 can have a CPU, memory and peripheral circuitry. The microcontroller 155 is electrically coupled to a wireless communication module 160 using either a standard or proprietary communication standard. Alternatively, the microcontroller 155 can include internally any or all circuitry of the smart device 100, including the wireless communication module 160. The microcontroller 155 preferably includes power savings or power management circuitry 145 and modes to reduce power consumption significantly when the microcontroller 155 is not active or is less active. The microcontroller 155 may contain at least one Analog-to-Digital Converter (ADC) channel for interfacing to the AFE 150.

The battery/power management module 145 preferably includes the electromagnetic field (EMF) scavenging device, but can alternatively run off of previously stored electrical power from the battery alone. The battery/power management module 145 powers all the circuitry in the smart device 100, including the camera 140, AFE 150, microcontroller 155, wireless communication module 160, and antenna 170. Even though the smart device 100 is preferably powered by continuously harvesting RF energy, it is beneficial to minimize power consumption. To minimize power consumption, the various tasks performed by the circuit should be repeated no more often than necessary under the circumstances.

Item storage information from the smart storage device 20 and other information from the microcontroller 155 is preferably transmitted wirelessly through a wireless communication module 160 and antenna 170. As stated above, the wireless communication component can use standard or proprietary communication protocols. Smart lids 100 can also communicate with each other to relay information about the current status of the structure or machine and the smart device 100 themselves. In each smart device 20, the transmission of this information may be scheduled to be transmitted periodically. The smart storage device 20 has a data storage medium (memory) to store data and internal status information, such as power levels, while the communication component is in an OFF state between transmission periods. On the other hand, once the communication commences in the ON state, the microcontroller 155 can execute the following tasks:

1. Neighbor discovery: in this task each smart device 100 sends a beacon identifying its location, capabilities (e.g. residual energy), status. 2. Cluster formation: cluster head will be elected based on the findings in (1). The cluster children communicate directly with their cluster head (CH). 3. Route discovery: this task interconnects the elected cluster heads together and finds the route towards the sink smart device (node) so that minimum energy is consumed. 4. Data transmission: the microcontroller processes the collected item data and based on the adopted data dissemination approach, the smart device 20 will do one of the following. (a) Transmit the data as is without considering the previous status; or (b) transmit the data considering the previous status. Here we can have several scenarios, which include: (i) transmitting the data if the change in reported item storage exceeds various threshold levels; and (ii) otherwise, do not transmit.

The device electronic of FIG. 4 operates with a big data discovery system that determines events that may lead to theft or product spoilage, for example. The items may have predetermined stress that should be monitored. Thus, for wine shipments, the stress can include temperature and humidity, for example. For breakable items such as glass or wine bottle or hard drives, the stress can include shock from hitting a floor, for example.

A stress module may be configured to detect stress as detected by the each smart item. The signal sent by the items collectively may indicate the amount of stress being generated and/or a prediction of the amount of stress that will be generated. The stress detection module may further be configured to detect a change in stress of non-smart devices associated with the unit. A prediction module may be configured to predict future stress based on past stress history as detected, environmental conditions, forecasted stress loads, among other factors. In some embodiments, the prediction module may predict future stress by building models of usage and weight being transported. For example, the prediction module may build models using machine learning based on support vector machines, artificial neural networks, or using other types of machine learning. For example, stress may correlate with the load carried by a bridge or an airplane structure. In other example, stress may correlate with temperature cycling when a structure is exposed to constant changes (such as that of an airplane).

FIGS. 5-10 describe exemplary embodiments of uses of storage device 20. Steps in FIGS. 5-10 may be omitted, rearranged, or combined.

FIG. 5 shows an exemplary process to receive an item into the storage device 20.
Select or order an item to be shipped (502)
Generate a passcode or PIN for a commercial carrier (504)
Request item be picked up by carrier for shipping and provide passcode/PIN to carrier (506)
Carrier picks up item, time of receipt of item, and passcode/PIN (508)
If enabled, item can capture shipment statistics (transit points,temperature, humidity, shock, . . . ) (510)
Item is brought to delivery address (512)
Delivery person accesses storage device and communicate passcode/PIN (514)
If authenticated, the storage device opens up a selected bin to receive the item (516)
Upload shipping statistics from item, and send statistics along with delivery time to server (518)
Notify user/recipient of delivery (520)

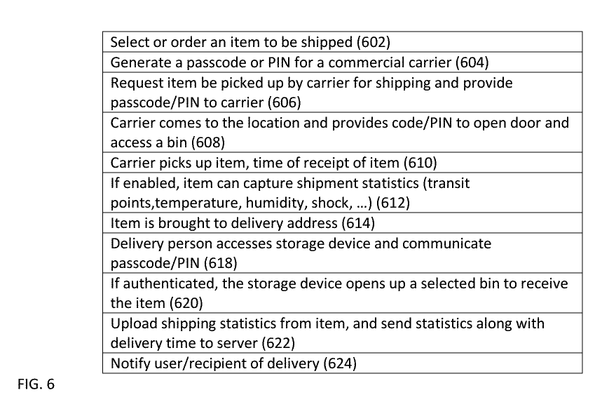

FIG. 6 shows an exemplary process to pickup an item from the storage device 20.
Select or order an item to be shipped (602)
Generate a passcode or PIN for a commercial carrier (604)
Request item be picked up by carrier for shipping and provide passcode/PIN to carrier (606)
Carrier comes to the location and provides code/PIN to open door and access a bin (608)
Carrier picks up item, time of receipt of item (610)
If enabled, item can capture shipment statistics (transit points,temperature, humidity, shock, . . . ) (612)
Item is brought to delivery address (614)
Delivery person accesses storage device and communicate passcode/PIN (618)
If authenticated, the storage device opens up a selected bin to receive the item (620)
Upload shipping statistics from item, and send statistics along with delivery time to server (622)
Notify user/recipient of delivery (624)

FIG. 7 shows an exemplar embodiment of a storage device that is solar powered with a temperature controlled housing to regulate temperature of grocery or food items deposited inside the storage devices. This embodiment allows an online service such as Amazon.com to deliver food from Whole Foods to the user in a manner that keeps the grocery items fresh. In one embodiment, the housing includes traditional refrigeration equipment, such as a fan/motor, condenser coil, evaporator coil, and coolant line. These elements are not shown in the drawings as they are traditional in substantially all refrigerators and are implied in the present invention. The referigerator for cooling the housing maintains air inside the interior space at a temperature below that of ambient air outside the interior space. The rear wall of the housing may include a plurality of vent openings in communication with the cooling refrigerator.

In the refrigeration cycle, there are five basic components: fluid refrigerant; a compressor, which controls the flow of refrigerant; the condenser coils (on the outside of the storage device); the evaporator coils (on the inside of the storage device); and an expansion device. Here's how they interact to cool stored items such as food. First, the compressor constricts the refrigerant vapor, raising its pressure, and pushes it into the coils on the outside of the refrigerator. When the hot gas in the coils meets the cooler air temperature of the kitchen, it becomes a liquid. Now in liquid form at high pressure, the refrigerant cools down as it flows into the coils inside the storage device. The refrigerant absorbs the heat inside, cooling down the air. 5. Last, the refrigerant evaporates to a gas, then flows back to the compressor, where the cycle starts all over.

A heater can be used in place of the refrigerator to keep food deliveries warm. For example, in case of a pizza delivery, a resistive coil or an infrared lamp can be powered up to keep the food delicious, for example.

When a delivery service provider attempts to deliver an item at, for example, a doorstep of a user's home or business. If the user is not available, the delivery service provider retrieves a code, bar code, or other form of identification of the item attempted to be delivered. The delivery service provider then checks with customer service or dispatch to determine if the storage space in the device of FIG. 1 is available and if the delivery service provider has permission to open the device of FIG. 1. This check can be made in a variety of ways, such as by telephone, by wireless device, or the like. If space is available, a locker shipping record is matched with a shipping record of the delivery item, and a record consisting of the storage cell record and item record is created and stored, to facilitate loading of the item in a specific cell of storage device 6 by the delivery service provider.

The storage device 1 or 6 also records the time in which a user may retrieve an item addressed for delivery to the user. During the process of retrieving a item from a cell, he user provides information, such as personal information to identify the user, by scanning or swiping identification to a reader in the device 1 or 6. The identification can be anything that identifies the user, such as a credit card, ATM card, government identification, and the like. The user may enter or scan a code to identify a specific delivery item. The code may be, for example, a bar code, a tracking number, or a number on a doortag left by a delivery service provider. The process then retrieves a shipping record from storage device 6. The process then determines if an item for this user has been stored in storage device 6. If not, the process quits, and may restart. If yes, then a sign-on screen is presented on user interface requesting a user's signature or login or ID scan using NFC. Then system unlocks the specific cell containing the item, and sets the status of that cell as “unusable.” Then the process then updates status of the door unlock. After the cell is unlocked at step 626, the user retrieves the item from the cell. The door of the cell may then be closed either automatically by system or by the user. If the cell is not closed, user interface may ask the user to close the cell, or system may automatically try to close the cell again.

The cell can be “opened” and “closed” in other ways besides unlocking a door, such as moving up or down, or tilting itself in and out to expose the delivery item. The user is asked to scan the item, and then the process moves to 636. Also, there may be sensors, scales, cameras, and the like inside the cell to determine if an item has been deposited or removed. A search may include searching all the shipment records on central computer system 24 which can determine if there is an item for that particular user with the expected tracking number, code, or ID number. If not, the user is informed that the item for that particular information does not exist, and may be asked to re-enter the information. If there is an item that matches the user's information, the system can inform the user of the item's location.

Other embodiments of the system will be apparent to those skilled in the art from consideration of the specification and practice of the system disclosed herein. It is intended that the specification and examples be considered as exemplary only, with a true scope and spirit of the system being indicated by the following claims. Although some embodiments have been described in detail with reference to the accompanying drawings, the present disclosure is not limited to such embodiments. It should be understood by those skilled in the art that various modifications, combinations, sub-combinations and alterations may occur depending on design requirements and other factors insofar as they are within the scope of the appended claims or the equivalents thereof. Further, it should be understood that, as used herein, the indefinite articles “a” and “an” mean “one or more” in open-ended claims containing the transitional phrase “comprising,” “including,” and/or “having.”

Various illustrative embodiments are described in reference to specific examples. The illustrative examples are selected to assist a person of ordinary skill in the art to form a clear understanding of, and to practice the various embodiments. However, the scope of systems, integrated circuits structures and devices that may be constructed to have one or more of the embodiments, and the scope of methods that may be implemented according to one or more of the embodiments, are in no way confined to the specific illustrative examples that have been presented. On the contrary, as will be readily recognized by persons of ordinary skill in the relevant arts based on this description, many other configurations, arrangements, and methods according to the various embodiments may be implemented.

To the extent positional designations such as top, bottom, upper, lower have been used in describing this invention, it will be appreciated that those designations are given with reference to the corresponding drawings, and that if the orientation of the device changes during manufacturing or operation, other positional relationships may apply instead. As described above, those positional relationships are described for clarity, not limitation.

The present invention has been described with respect to particular embodiments and with reference to certain drawings, but the invention is not limited thereto, but rather, is set forth only by the claims. The drawings described are only schematic and are non-limiting. In the drawings, for illustrative purposes, the size of various elements may be exaggerated and not drawn to a particular scale. It is intended that this invention encompasses inconsequential variations in the relevant tolerances and properties of components and modes of operation thereof. Imperfect practice of the invention is intended to be covered.

Where the term “comprising” is used in the present description and claims, it does not exclude other elements or steps. Where an indefinite or definite article is used when referring to a singular noun, e.g. “a” “an” or “the”, this includes a plural of that noun unless something otherwise is specifically stated. Hence, the term “comprising” should not be interpreted as being restricted to the items listed thereafter; it does not exclude other elements or steps, and so the scope of the expression “a device comprising items A and B” should not be limited to devices consisting only of components A and B.

What is claimed is:

1. A system to securely receive an item for delivery or pick-up in a predetermined location, comprising:
a housing with a storage chamber, a door, and a lock to secure the door to the housing;
a cover for the housing with a decor to hide the housing and provide a decor matching a theme of the predetermined location;
a controller to open the door upon authentication of a delivery or pick up person;
a sensor to detect presence or absence of the item; and
a wireless transceiver coupled to the controller to communicate with a recipient that the item has been received or picked up.

2. The system of claim 1, comprising a refrigeration module coupled to the housing.

3. The system of claim 1, comprising a heater module coupled to the housing.

4. The system of claim 1, comprising a refrigeration and heating module coupled to the housing.

5. The system of claim 1, comprising a solar panel coupled to the housing.

6. The system of claim 1, comprising a near field communication (NFC), WiFi or Bluetooth wireless unit coupled to the controller.

7. The system of claim 1, comprising a Z-Wave wireless unit coupled to the controller.

8. The system of claim 1, wherein the housing blends in with plants or items in the front of the house to inconspicuously receive a shipping item.

9. The system of claim 1, comprising an actuator coupled to the controller to open or close the door.

10. The system of claim 1, comprising a motor or a latch coupled to the controller to open or close the door.

11. The system of claim 1, wherein the housing comprises a statute.

12. The system of claim 1, wherein the housing comprises furniture.

13. The system of claim 1, wherein the housing comprises plant or rock container.

14. A method to securely receive an item for delivery or pick-up in a predetermined location, comprising:
installing a housing with a storage chamber, a door, and a lock to secure the door to the housing;
covering for the housing with a decor to hide the housing and provide a decor matching a theme of the predetermined location;
controlling to open the door upon authentication of a delivery or pick up person;
detecting presence or absence of the item; and
communicating using a wireless transceiver with a recipient that the item has been received or picked up.

15. The method of claim 14, comprising cooling the storage chamber with a refrigeration module coupled to the housing.

16. The method of claim 14, comprising heating the storage chamber with a heater module coupled to the housing.

17. The method of claim 14, comprising heating or cooling the storage chamber with a refrigeration and heating module coupled to the housing.

18. The method of claim 14, comprising scavenging energy to power the controller.

19. The method of claim 14, comprising powering the storage chamber with AC power or solar power.

20. The method of claim 14, comprising inconspicuously embedding the housing in a statute, a furniture, a plant container, a rock container.
